(19) United States
(12) Patent Application Publication
(10) Pub. No.: US 2017/0132511 A1
(43) Pub. Date: May 11, 2017

(54) SYSTEMS AND METHODS FOR UTILIZING COMPRESSED CONVOLUTIONAL NEURAL NETWORKS TO PERFORM MEDIA CONTENT PROCESSING

(71) Applicant: Facebook, Inc., Menlo Park, CA (US)

(72) Inventors: Yunchao Gong, Sunnyvale, CA (US); Liu Liu, Marina Del Rey, CA (US); Lubomir Bourdev, Mountain View, CA (US); Ming Yang, Foster City, CA (US); Robert D. Fergus, New York, NY (US)

(21) Appl. No.: 14/982,874

(22) Filed: Dec. 29, 2015

Related U.S. Application Data
(60) Provisional application No. 62/253,623, filed on Nov. 10, 2015.

(51) Int. Cl. G06N 3/08; G06Q 50/00

(52) U.S. Cl. CPC G06N 3/08; G06Q 50/01

(57) ABSTRACT

Systems, methods, and non-transitory computer-readable media can receive a compressed convolutional neural network (CNN). A media content item to be processed can be acquired. The compressed CNN to can be utilized to apply a media processing technique to the media content item to produce information about the media content item. It can be determined, based on at least some of the information about the media content item, whether to transmit at least a portion of the media content item to one or more remote servers for additional media processing.

### CROSS-REFERENCE TO RELATED APPLICATIONS

This application claims priority to U.S. Provisional Patent Application No. 62/253,623, filed on Nov. 10, 2015 and entitled “SYSTEMS AND METHODS FOR UTILIZING COMPRESSED CONVOLUTIONAL NEURAL NETWORKS TO PERFORM MEDIA CONTENT PROCESSING”, which is incorporated herein by reference.

### FIELD OF THE INVENTION

The present technology relates to the field of media processing. More particularly, the present technology relates to techniques for utilizing compressed convolutional neural networks to perform media content processing.

### BACKGROUND

Today, people often utilize computing devices (or systems) for a wide variety of purposes. Users can use their computing devices to, for example, interact with one another, access content, share content, and create content. In some cases, users can utilize their computing devices to generate, download, view, access, or otherwise interact with media content, such as images, videos, and audio. For example, users of a social networking system (or service) can, via their computing devices, download media content for viewing, upload media content for sharing, or interact with information associated with media content.

In some instances, media processing can be performed or applied with respect to media content. Under conventional approaches rooted in computer technology, media processing techniques performed using computing systems (or devices) with limited resources, such as smartphones or tablets, can be expensive or inefficient. In one example, performing media processing on a computing system with limited processing speed, memory, or power can be slow, inaccurate, and can consume a significant amount of battery life. As such, conventional approaches can create challenges for or reduce the overall experience associated with utilizing, accessing, or interacting with media content.

### SUMMARY

Various embodiments of the present disclosure can include systems, methods, and non-transitory computer readable media configured to receive a compressed convolutional neural network (CNN). A media content item to be processed can be acquired. The compressed CNN can be utilized to apply a media processing technique to the media content item to produce information about the media content item. It can be determined, based on at least some of the information about the media content item, whether to transmit at least a portion of the media content item to one or more remote servers for additional media processing.

In an embodiment, at least the portion of the media content item can be transmitted to the one or more remote servers for the additional media processing. One or more objects depicted in at least the portion of the media content item can be enabled to be recognized based on the additional media processing. Information associated with the one or more objects recognized based on the additional media processing can be received.

In an embodiment, the compressed CNN can be generated based on a compression process performed remotely from a computing system at which the compressed CNN can be received.

In an embodiment, the compression process can be at least one of selected or configured based on one or more properties associated with the computing system.

In an embodiment, the compression process can utilize a matrix factorization method.

In an embodiment, the compression process can utilize a vector quantization method.

In an embodiment, the vector quantization method can be associated with at least one of binarization, scalar quantization, product quantization, or residual quantization.

In an embodiment, the information about the media content item can include a score indicating a level of confidence associated with recognizing, by the media processing technique, one or more objects of interest depicted in the media content item.

In an embodiment, determining whether to transmit at least the portion of the media content item to the one or more remote servers for the additional media processing can further comprise determining whether the score at least meets a specified confidence threshold.

In an embodiment, the information about the media content item can be produced in real-time based on utilizing the compressed CNN to apply the media processing technique to the media content item.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example compressed convolutional neural network (CNN) module configured to facilitate utilizing compressed convolutional neural networks to perform media content processing, according to an embodiment of the present disclosure.

FIG. 2 illustrates an example additional media processing module configured to facilitate utilizing compressed convolutional neural networks to perform media content processing, according to an embodiment of the present disclosure.

FIG. 3 illustrates an example scenario associated with utilizing compressed convolutional neural networks to perform media content processing, according to an embodiment of the present disclosure.

FIG. 4 illustrates an example scenario associated with utilizing compressed convolutional neural networks to perform media content processing, according to an embodiment of the present disclosure.

FIG. 5 illustrates an example method associated with utilizing compressed convolutional neural networks to perform media content processing according to an embodiment of the present disclosure.

FIG. 6 illustrates an example method associated with utilizing compressed convolutional neural networks to perform media content processing, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Utilizing Compressed Convolutional Neural Networks to Perform Media Content Processing

People use computing systems (or devices) for various purposes. Users can utilize their computing systems to establish connections, engage in communications, interact with one another, and/or interact with various types of content. In some cases, computing devices can include or correspond to cameras capable of capturing or recording media content, such as images or videos (including sets of video image frames or still frames). Often times, media content such as an image can depict, represent, or include one or more objects. Examples of objects within images can include, but are not limited to, users (e.g., user faces), pets, plants, products, vehicles, vessels, structures, landmarks, scenes, actions and/or various other items, item portions, or activities.

Conventional approaches rooted in computer technology for media processing can attempt to identify or recognize objects in images. However, conventional media processing approaches for recognizing objects typically require a significant amount of computing resources, such as processing speed, memory, and/or power. Moreover, it is becoming increasingly commonplace for users to utilize computing systems with limited resources to access or interact with media content. For example, users often use their smartphones or tablets to capture, view, and/or share images. In many instances, utilizing conventional approaches for recognizing objects in the images with such computing systems having limited resources can be challenging, inefficient, and undesirable.

Due to these or other concerns, conventional approaches can be disadvantageous or problematic. Therefore, an improved approach can be beneficial for addressing or alleviating various drawbacks associated with conventional approaches. Based on computer technology, the disclosed technology can utilize compressed convolutional neural networks to perform media content processing. Various embodiments of the present disclosure can receive a compressed convolutional neural network (CNN). A media content item to be processed can be acquired. The compressed CNN can be utilized to apply a media processing technique to the media content item to produce information about the media content item. It can be determined, based on at least some of the information about the media content item, whether to transmit at least a portion of the media content item to one or more remote servers for additional media processing. It is contemplated that there can be many variations and/or other possibilities associated with the disclosed technology.

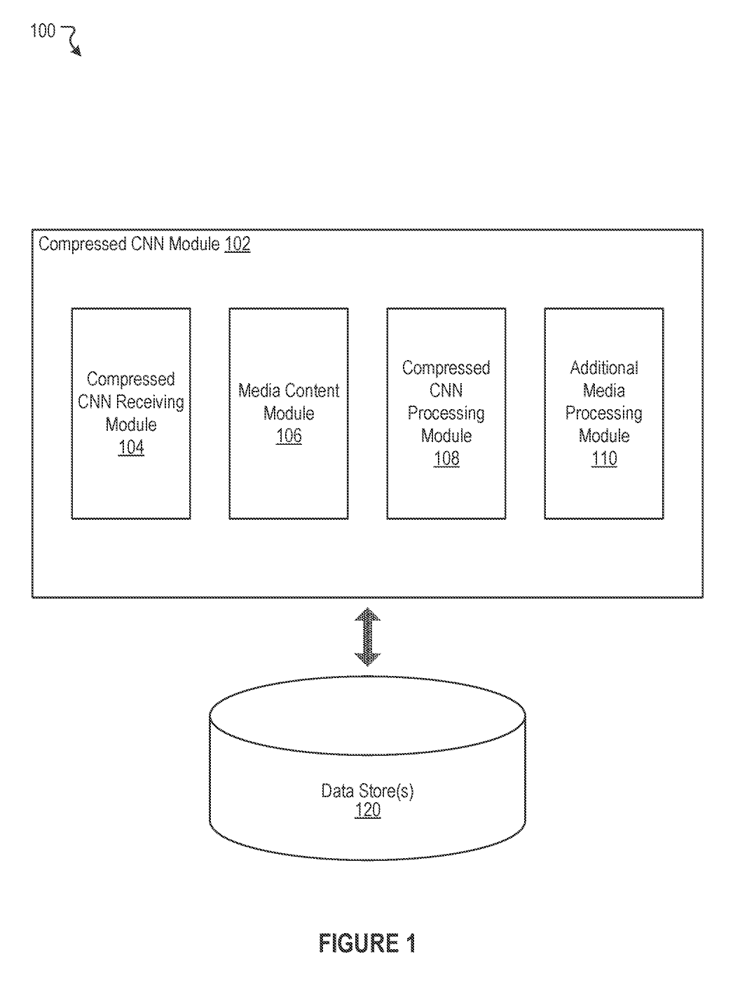

FIG. 1 illustrates an example system including an example compressed convolutional neural network (CNN) module 102 configured to facilitate utilizing compressed convolutional neural networks to perform media content processing, according to an embodiment of the present disclosure. As shown in the example of FIG. 1, the compressed CNN module 102 can include a compressed CNN receiving module 104, a media content module 106, a compressed CNN processing module 108, and an additional media processing module 110. In some instances, the example system 100 can include at least one data store 120. The components (e.g., modules, elements, etc.) shown in this figure and all figures herein are exemplary only, and other implementations may include additional, fewer, integrated, or different components. Some components may not be shown so as not to obscure relevant details.

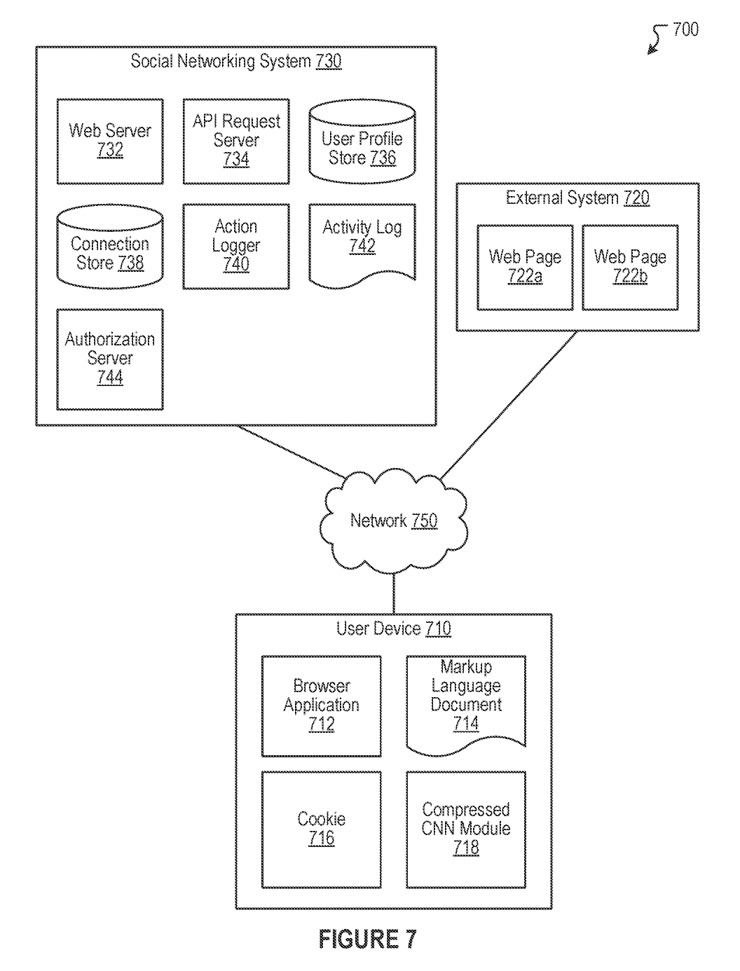

In some embodiments, the compressed CNN module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the compressed CNN module 102 can be implemented, in part or in whole, as software running on one or more computing devices or systems, such as on a user or client computing device. For example, the compressed CNN module 102 or at least a portion thereof can be implemented as or within an application (e.g., app), a program, an applet, or an operating system, etc., running on a user computing device or a client computing system, such as the user device 710 of FIG. 7. In another example, the compressed CNN module 102 or at least a portion thereof can be implemented using one or more computing devices or systems that include one or more servers, such as network servers or cloud servers. In some instances, the compressed CNN module 102 can, in part or in whole, be implemented within or configured to operate in conjunction with a social networking system (or service), such as the social networking system 730 of FIG. 7. It should be appreciated that there can be many variations or other possibilities.

The compressed CNN receiving module 104 can be configured to facilitate receiving a compressed convolutional neural network (CNN). The compressed CNN can, for instance, correspond to a dense or deep CNN that has undergone an compression algorithm, technique, or process. In some embodiments, the compressed CNN can be generated based on a compression process performed remotely from a local computing system (or device) on which the compressed CNN module 102 is implemented, residing, or running. For example, one or more servers remote or separate from the computing system can perform the compression process (e.g., method, algorithm, technique, etc.). Due to the compression process, the resulting compressed CNN can require less resources at the computing system while still maintaining reliable performance.

In some embodiments, the compression process can utilize a matrix factorization method. For instance, singular-value decomposition (SVD) can be used to factorize a parameter matrix associated with a CNN for recognizing (or detecting) objects depicted in a media content item, such an image. Given a parameter WεR^{m×n} in one dense connected layer, it can be factorized as W=U SV^{T}, where UεR^{m×m} and VεR^{n×n} are two dense orthogonal matrices and SεR^{m×n} is a diagonal matrix. In some instances, in order to approximate W using two smaller matrices, the top k singular vectors can be picked in U and V with corresponding eigenvalues in S, to reconstruct W: Ŵ=Û Ŝ\hat{V}^{T}, where ÛεR^{m×k} and \hat{V}εR^{n×k} are two submatrices that correspond to the leading k singular vectors in U and V. The diagonal elements in ŜεR^{k×k} correspond to the largest k singular values. The approximation of SVD is controlled by the decay along the eigenvalues in S. SVD can be optimal in the sense of a Frobenius norm, which can minimize the MSE error between the approximated Ŵ and the original W. The two low-rank matrices Û and \hat{V}, as well as the eigenvalues, are to be stored. So the compression rate given m, n, and k can be computed as mn/k(m+n+1).

Moreover, in some embodiments, the compression process can utilize a vector quantization method. The vector quantization method can, for instance, be associated with at least one of binarization, scalar quantization, product quantization, or residual quantization. In one example, the vector quantization method can be associated with binarization. To quantize parameter matrices, given the parameter W, the sign of the matrix can be taken as:

$${\hat{W}}_{ij} = \{ \begin{matrix}1 if {W}_{ij} \geq 0 , \\ - 1 if {W}_{ij} \leq 0.\end{matrix}$$

In some cases, part of the parameters (e.g., neurons) can be set to 0 during training. In some cases, this binarization approach can turn each neuron “on” if it is positive and can turn each neuron “off” if it is negative. From a geometric point of view, assuming that dense connected layers are a set a hyperplanes, each hyperplane are actually being rounded to its nearest coordinate. This approach can, for instance, compress the data by 32 times, since each neuron can be represent by one bit.

In another example, the vector quantization method can be associated with scalar quantization, such as by performing scalar quantization to the parameters. For WεR^{m×n}, all of its scalar values can be collected as wεR^{1×mn}. In some cases, k-means clustering can be performed to the values: min Σᵢ^{mn}Σⱼ^{k}∥wᵢ−c_{z}∥₂², where w and c are both scalars. After the clustering, each value in w is assigned a cluster index, and a codebook can be formed of c^{1×k} the cluster centers. During the prediction, the values for each wᵢⱼ in c can be directly looked up. Thus, the reconstructed matrix is: Ŵᵢⱼ=c_{z}, where min_{z}∥Wᵢⱼ−c_{z}∥₂². For this approach, only the indexes and the codebook need to be stored as the parameters. Given the k centers, only log₂(k) bits are needed to encode the centers. For instance, if k=256 centers are used, only 8 bits are needed per cluster index. Thus, the compression rate can be 32/log₂(k), assuming that floating numbers are used for the original W and assuming that the codebook is negligible.

In a further example, the vector quantization method can be associated with product quantization, which can explore the redundancy of structures in vector space. In some instances, the vector space can be partitioned into many disjoint subspaces, and quantization can be performed in each subspace. In some cases, given the matrix W, it can be partitioned column-wise into several submatrices: W=[W¹, W², . . . , W⁸], where

$${W}^{i} ∈ {R}^{m \times ( \frac{n}{s} )}$$

assuming n is divisible by s. In some instances, k-means clustering can be performed to each submatrix Wⁱ: min Σ_{z}^{m}Σⱼ^{k}∥w_{z}ⁱ−cⱼⁱ∥₂², where w_{z}ⁱ denotes the z-th row of submatrix Wⁱ, and cⱼⁱ denotes the j-th row of sub-codebook

$${C}^{i} ∈ {R}^{k \times ( \frac{n}{s} )} .$$

For each subvector w_{z}ⁱ, only its corresponding cluster index and the codebooks need to be stored. Thus, the reconstructed matrix is: Ŵ=[Ŵ¹, Ŵ², . . . , Ŵ⁸], where ŵ_{z}ⁱ=ĉⱼⁱ, where minⱼ∥w_{z}ⁱ−cⱼⁱ∥₂². In some cases, product quantization can be applied to either the x-axis or the y-axis of the matrix. For this approach, the cluster indexes and codebooks for each subvector need to be stored. The codebook may not necessarily be negligible. The compression rate for this approach can be (32mn)/(32kn+log₂(k)ms).

In another example, the vector quantization method can be associated with residual quantization, which can first quantize the vectors into k centers and then recursively quantize the residuals. For instance, given a set of vectors wᵢ, iε1, . . . , m, at a first stage, the set of vectors can be quantized into k different vectors using k-means clustering: min Σ_{z}^{m}Σⱼ^{k}∥w_{z}−cⱼ¹∥₂². Every vector w_{z} can be represented by its closet center cⱼ¹. Next, the residual r_{z}¹ between w_{z} and cⱼ¹ can be computed for all the data points, and the residual vectors r_{z}¹ can be recursively quantized into k different code words cⱼ². Finally, a vector can be reconstructed by adding its corresponding centers at each stage: ŵ_{z}=cⱼ¹+cⱼ²+ . . . , cⱼ^{t}, given that t iterations have been recursively performed. In some cases, all the codebooks for each iteration need to be stored. The compression rate can be m/(tk+log₂(k)tn).

The examples described above include various vector quantization methods for compressing matrices associated with convolutional neural networks, such as deep or dense convolutional neural networks. In some cases, scalar quantization can capture the redundancy for each neuron (single scalar), while product quantization can explore the local redundancy structure, and residual quantization can attempt to explore the global redundancy structure between weight vectors. It should be appreciated that all examples herein are provided for illustrative purposes and that there can be many variations or other possibilities associated with the disclosed technology.

In some implementations, the compression process can be selected or configured based on one or more properties associated with the computing system. For instance, the compression process used to produce the compressed CNN can be based on what type of device/system the computing system is, what operating system the computing system is running, and/or what resources are associated with or available to the computing system, etc. Again, many variations are possible.

The media content module 106 can be configured to facilitate acquiring a media content item to be processed. Examples of media content items can include, but are not limited to, images (e.g., photos, pictures, video still frames, animated images, etc.) and videos (e.g., sets of video still frames with or without audio). In some cases, a user of the computing system and/or of a social networking system (or service) can provide the media content item to be acquired by the media content module 106. For instance, the user can select an image for uploading, downloading, sharing, posting, publishing, transmitting, and/or for other purposes. The user-selected image can correspond to the media content item acquired by the media content module 106. In some cases, the computing system can select or provide the media content item to be acquired by the media content module 106. In one example, the computing system can provide an image or a set of images representing a camera view (e.g., a real-time stream of one or more images of what is being perceived or captured by a camera of the computing system). The image (or at least one image in the set of images) can be acquired by the media content module 106 as the media content item. In another example, the media content module 106 can perform a media content selection process, such as a random media content selection algorithm or a recently created/saved media content selection algorithm, in order to select or acquire the media content item. It should be understood that many variations are possible.

The compressed CNN processing module 108 can be configured to facilitate utilizing the compressed CNN to apply a media processing technique to the media content item to produce information about the media content item. In some implementations, the media processing technique can enable one or more objects (e.g., faces, facial features, pets, products, logos, landmarks, scenes, actions, etc.) to be detected. For example, the media processing technique can detect and identify where in the media content item a particular object of interest may be located or depicted. The location of the detected particular object within the media content item can be included in the information produced from the media processing technique. In some embodiments, the media processing technique can enable one or more objects to be recognized or identified. For instance, the media processing technique can provide identifying information (e.g., a name, a tag, a classification, a label, etc.) about a face, an item, a scene, or an activity, etc., depicted in the media content item.

In some cases, the information about the media content item can be produced in (or near) real-time based on utilizing the compressed CNN, by the compressed CNN processing module 108, to apply the media processing technique to the media content item. For example, as discussed previously, if the computing system provides the real-time stream of the one or more images representing what is being perceived or captured by the camera of the computing system, then the compressed CNN processing module 108 can utilize the compressed CNN information to apply the media processing technique to the one or more images to produce information about the one or more images in (or near) real-time. In this example, the information can reflect, based on a confidence level, in (or near) real-time a detection or recognition of one or more particular objects of interest (e.g., faces, facial features, etc.) within one or more images or a location(s) where one or more particular objects of interest are depicted within the one or more images.

Moreover, in some cases, the information about the media content item produced from the media processing technique can include a score indicating a level of confidence associated with recognizing, by the media processing technique, one or more objects of interest depicted in the media content item. In one example, the information about the media content item can include a first score indicating a level of confidence associated with recognizing a particular user's face depicted in the media content item, a second score indicating a confidence level associated with recognizing a cat depicted in the media content item, a third score indicating a confidence level associated with recognizing that an outdoor scene is depicted in the media content item, and so forth. As discussed previously, it should be appreciated that many variations associated with the disclosed technology are possible.

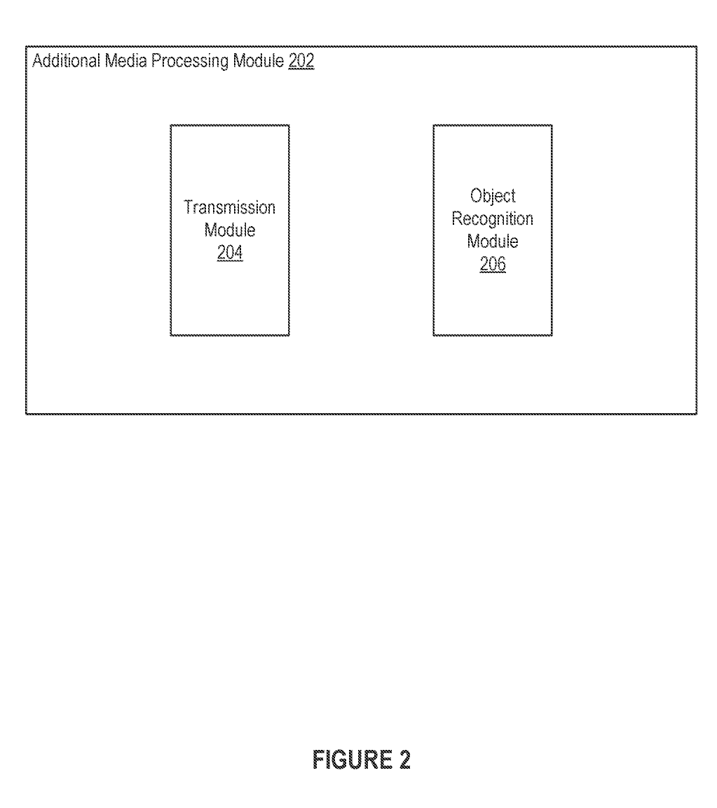

Furthermore, the additional media processing module 110 can be configured to facilitate determining, based on at least some of the information about the media content item, whether to transmit at least a portion of the media content item to one or more remote servers for additional media processing. The additional media processing module 110 will be discussed in more detail below with reference to FIG. 2.

Additionally, in some embodiments, the compressed CNN module 102 can be configured to communicate and/or operate with the at least one data store 120, as shown in the example system 100. The at least one data store 120 can be configured to store and maintain various types of data. In some implementations, the at least one data store 120 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 120 can store information associated with users, such as user identifiers, user information, profile information, user locations, user specified settings, content produced or posted by users, and various other types of user data. In some embodiments, the at least one data store 120 can store information that is utilized by the compressed CNN module 102, such as media content and information associated with compressed convolutional neural networks. Again, it is contemplated that there can be many variations or other possibilities associated with the disclosed technology.

FIG. 2 illustrates an example additional media processing module 202 configured to facilitate utilizing compressed convolutional neural networks to perform media content processing, according to an embodiment of the present disclosure. In some embodiments, the additional media processing module 110 of FIG. 1 can be implemented as the example additional media processing module 202. As shown in FIG. 2, the additional media processing module 202 can include a transmission module 204 and an object recognition module 206.

As discussed above, the additional media processing module 202 can be configured to facilitate determining, based on at least some of the information about a media content item, whether to transmit at least a portion of the media content item to one or more remote servers for additional media processing. In some cases, the additional media processing module 202 can determine whether to transmit at least the portion of the media content item to the one or more remote servers for the additional media processing based on determining whether a score at least meets a specified confidence threshold. For instance, the score can indicate a level of confidence associated with recognizing one or more objects of interest depicted in the media content item. If the score at least meets the specified confidence threshold, the additional media processing module 202 can determine that the additional media processing may not be necessary. If, however, the score is less than the specified confidence threshold, then the additional media processing module 202 can determine to utilize the transmission module 204 to transmit at least the portion of the media content item to the one or more remote servers for the additional media processing.

In some embodiments, the additional media processing module 202 can determine or acknowledge that one or more objects of interest have been detected in the media content item via a media processing technique applied by a computing system. At least a portion of the media content item (e.g., an image patch) in which the detected one or more objects are depicted can be extracted from or cropped out of the media content item. At least this portion of the media content item in which the one or more objects are detected can be transmitted, by the transmission module 204, to the one or more remote servers (remote from the computing system) to perform the additional media processing.

In some cases, the one or more objects depicted in at least the portion of the media content item can be enabled by the object recognition module 206 to be recognized based on the additional media processing. For instance, the object recognition module 206 can provide an instruction, a command, or an indication that signifies to the one or more remote servers to perform the additional media processing to recognize or identify the one or more objects. In another instance, the object recognition module 206 can enable the one or more objects to undergo the additional media processing when the transmission of at least the portion of the media content item to the one or more remote servers is successful or complete. In a further instance, the object recognition module 206 can enable the one or more objects to undergo the additional media processing when only the portion of the media content item, rather than the entirety, is transmitted. Furthermore, information associated with the one or more objects being recognized can be produced from the additional media processing. The information associated with the one or more objects recognized based on the additional media processing can be received by the computing system. For example, names, labels, classifications, or identifiers for the objects produced from the additional media processing can be transmitted to and received by the computing system.

Moreover, in some implementations, the additional media processing module 202 can determine that one or more privacy/security settings, preferences, and/or instructions should prevent at least the portion of the media content item from being transmitted to the one or more remote servers. Accordingly, the additional media processing module 202 can control the transmission of the media content item or portion thereof based on the privacy/security settings, preferences, and/or instructions. In some embodiments, the additional media processing module 202 can determine whether to transmit at least the portion of the media content item to the one or more remote servers for the additional media processing based on user information, network conditions, computing system state/conditions, and/or other factors. Again, many variations are possible.

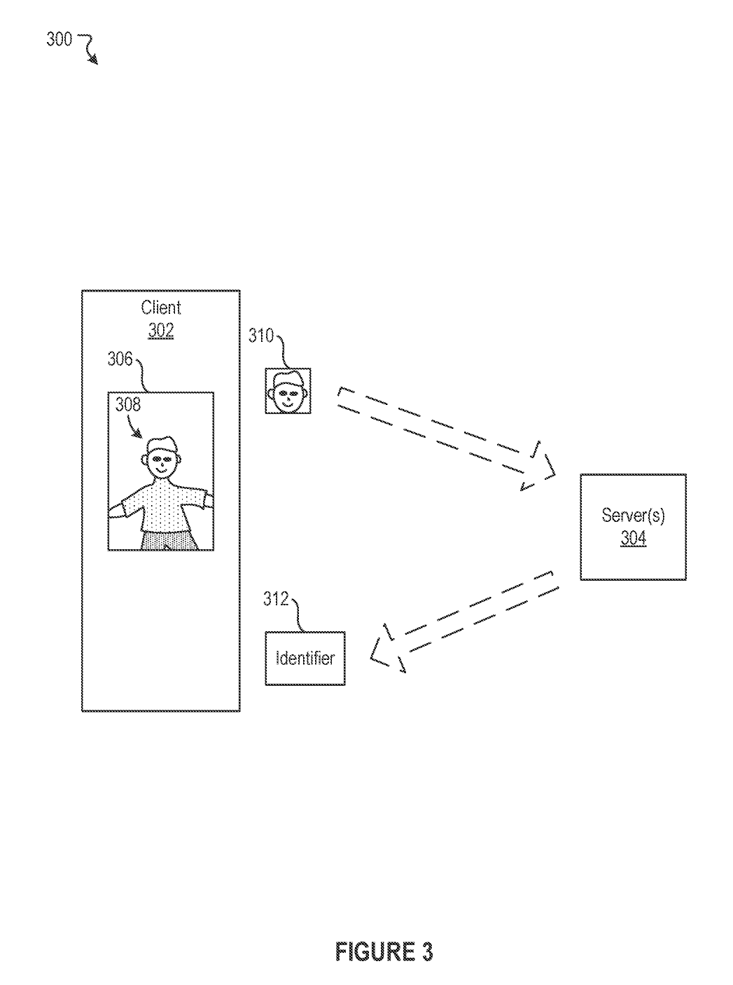

FIG. 3 illustrates an example scenario 300 associated with utilizing compressed convolutional neural networks to perform media content processing, according to an embodiment of the present disclosure. The example scenario 300 illustrates a client 302, such as a client computing system or device, and a server(s) 304 remote or separate from the client 302.

As shown in the example of FIG. 3, an image 306 can be selected or acquired at the client 302. The image 306 can include (i.e., represent, depict, show, display, etc.) a face 308 of a user. In this example, a media processing technique utilizing a compressed CNN received at the client 302 can be applied, at the client 302, to the image 306 to produce information associated with the image 306. In this example, the information can indicate that the user's face or face object 308 has been detected in the image 306. Having detected the face object 308, an image portion 310 including the face object 308 can be extracted from or cropped out of the image 306. The client 302 can then transmit the image portion 310 to the remote server(s) 304. The remote server(s) 304 can perform additional media processing with respect to the image portion 310 to recognize the face object 308 and determine identifying information (e.g., an identifier 312) for the face object 308. The remote server(s) 304 can then provide or transmit the identifying information, such as the identifier 312 for the face object 308, to be received at the client 302. Many variations are possible.

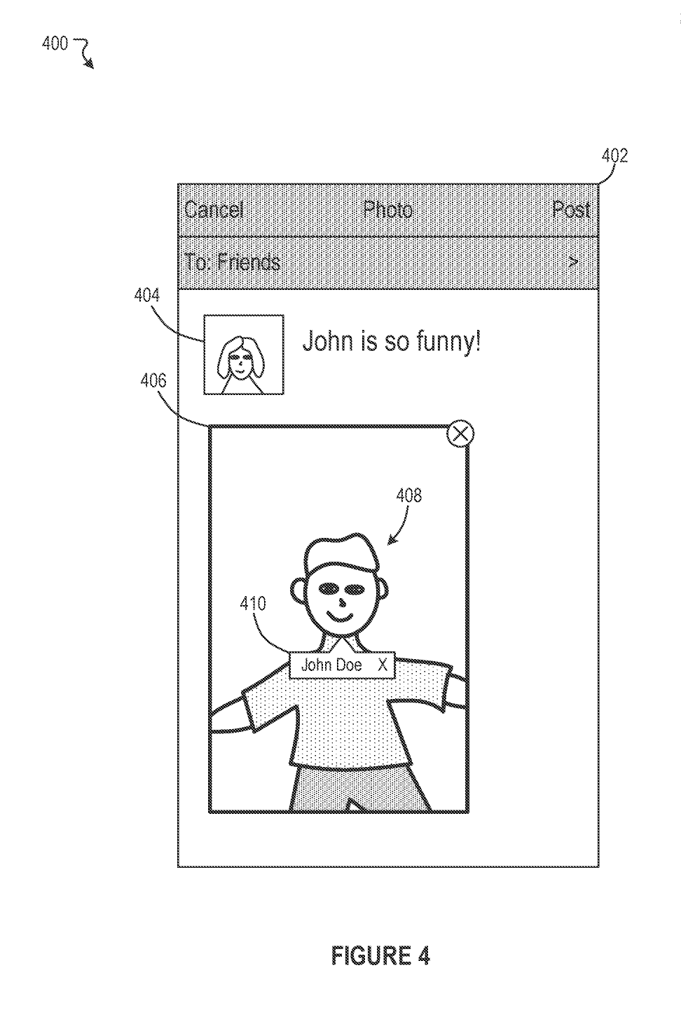

FIG. 4 illustrates an example scenario 400 associated with utilizing compressed convolutional neural networks to perform media content processing, according to an embodiment of the present disclosure. The example scenario 400 illustrates an example interface 402, such as a user interface of an application utilizing or otherwise associated with the disclosed technology.

As shown in FIG. 4, the example interface 402 can enable a first user 404 to select an image 406 to be uploaded, posted, shared, or sent, etc., via a social networking system. When the first user 404 selects the image 406, the image 406 can be acquired by a computing system such as the first user's smartphone or tablet, which may have limited resources. The image 406 can, for example, include a second user, such as a friend or social connection of the first user 404. In particular, the image 406 can include the second user's face 408.

In this example scenario 400, subsequent to a selection of the image 406 by the first user 404, if a media processing technique utilizing a compressed CNN performed at the computing system is unable to recognize the second user's face or face object 408, the media processing technique can attempt to detect the second user's face or face object 408. If the face object 408 is detected, then an image portion including the second user's face object 408 can be provided or transmitted from the computing system to one or more remote servers for additional media processing. In this example, information such as an identifier 410 can be determined or produced based on the additional media processing (e.g., at least one face recognition process). The identifier 410 can indicate a name of the second user (“John Doe”). The one or more remote servers can then provide or transmit the information (including the identifier 410) produced from the additional media processing to be received at the computing system of the first user 404. Again, many variations are possible.

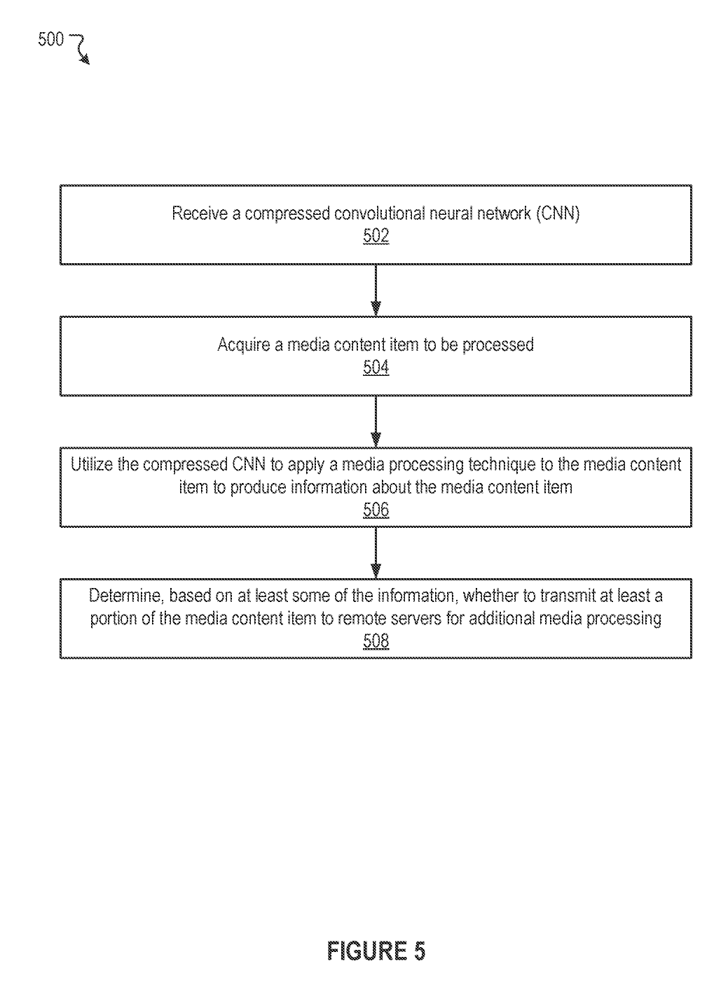

FIG. 5 illustrates an example method 500 associated with utilizing compressed convolutional neural networks to perform media content processing, according to an embodiment of the present disclosure. It should be appreciated that there can be additional, fewer, or alternative steps performed in similar or alternative orders, or in parallel, within the scope of the various embodiments unless otherwise stated.

At block 502, the example method 500 can receive a compressed convolutional neural network (CNN). At block 504, the example method 500 can acquire a media content item to be processed. At block 506, the example method 500 can utilize the compressed CNN to apply a media processing technique to the media content item to produce information about the media content item. At block 508, the example method 500 can determine, based on at least some of the information about the media content item, whether to transmit at least a portion of the media content item to one or more remote servers for additional media processing.

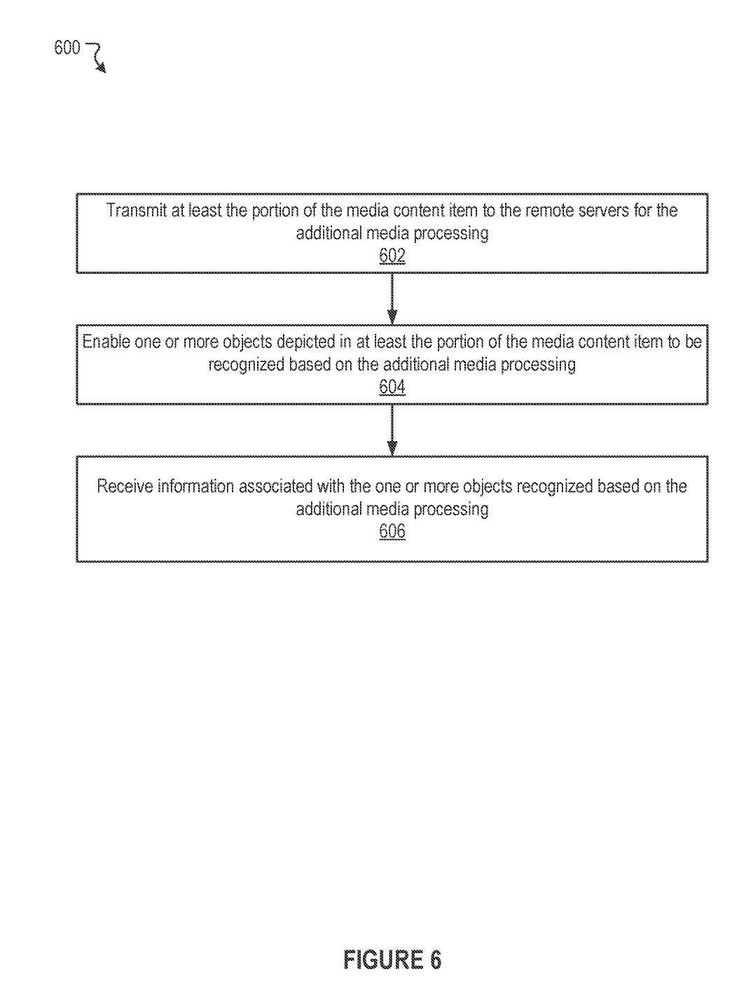

FIG. 6 illustrates an example method 600 associated with utilizing compressed convolutional neural networks to perform media content processing, according to an embodiment of the present disclosure. As discussed, it should be understood that there can be additional, fewer, or alternative steps performed in similar or alternative orders, or in parallel, within the scope of the various embodiments unless otherwise stated.

At block 602, the example method 600 can transmit at least the portion of the media content item to the one or more remote servers for the additional media processing. At block 604, the example method 600 can enable one or more objects depicted in at least the portion of the media content item to be recognized based on the additional media processing. At block 606, the example method 600 can receive information associated with the one or more objects recognized based on the additional media processing.

It is contemplated that there can be many other uses, applications, features, possibilities, and/or variations associated with the various embodiments of the present disclosure. In one example, the disclosed technology can be utilized to implement a smart self-timer for a camera application running on a computing system, such that the camera application captures an image or video subsequent to detecting a user's face in the camera view. In another example, users can, in some cases, choose whether or not to opt-in to utilize the disclosed technology. The disclosed technology can, for instance, also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet. In some embodiments, the social networking system 730 can include or correspond to a social media system (or service).

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the user device 710 can include a compressed CNN module 718. The compressed CNN module 718 can, for example, be implemented as the compressed CNN module 102 of FIG. 1. As discussed previously, it should be appreciated that there can be many variations or other possibilities. For example, in some instances, the compressed CNN module (or at least a portion thereof) can be included or implemented in the social networking system 730. Other features of the compressed CNN module 718 are discussed herein in connection with the compressed CNN module 102.

### Hardware Implementation

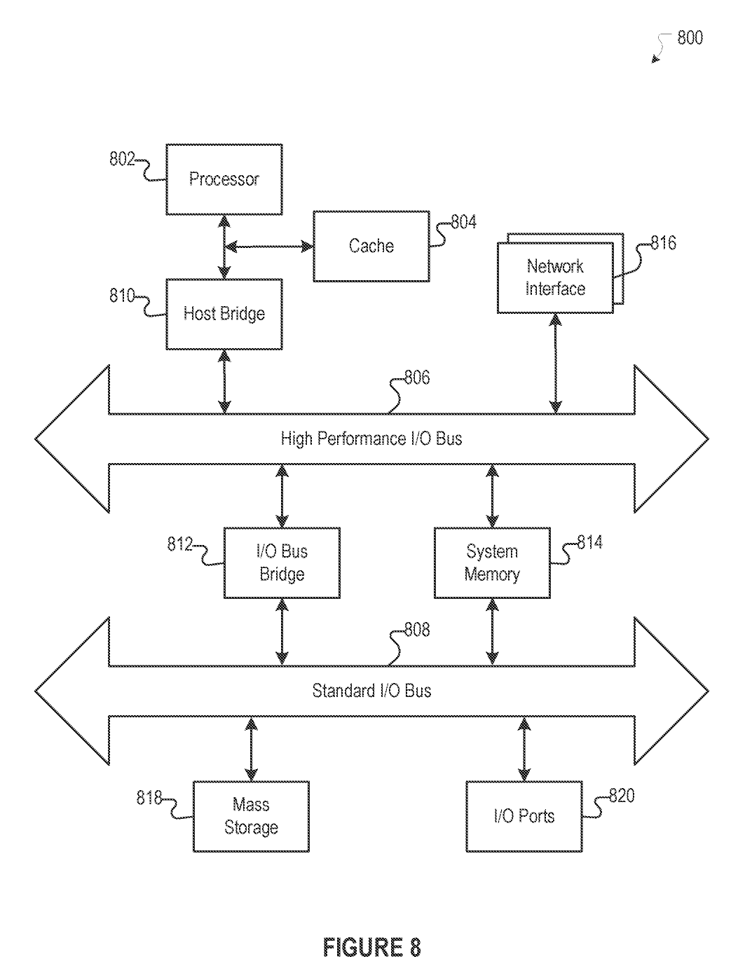

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments. Furthermore, reference in this specification to “based on” can mean “based, at least in part, on”, “based on at least a portion/part of”, “at least a portion/part of which is based on”, and/or any combination thereof.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a compressed convolutional neural network (CNN);
acquiring, by the computing system, a media content item to be processed;
utilizing, by the computing system, the compressed CNN to apply a media processing technique to the media content item to produce information about the media content item; and
determining, by the computing system, based on at least some of the information about the media content item, whether to transmit at least a portion of the media content item to one or more remote servers for additional media processing.

2. The computer-implemented method of claim 1, further comprising:
transmitting at least the portion of the media content item to the one or more remote servers for the additional media processing;
enabling one or more objects depicted in at least the portion of the media content item to be recognized based on the additional media processing; and
receiving information associated with the one or more objects recognized based on the additional media processing.

3. The computer-implemented method of claim 1, wherein the compressed CNN is generated based on a compression process performed remotely from the computing system.

4. The computer-implemented method of claim 3, wherein the compression process is at least one of selected or configured based on one or more properties associated with the computing system.

5. The computer-implemented method of claim 3, wherein the compression process utilizes a matrix factorization method.

6. The computer-implemented method of claim 3, wherein the compression process utilizes a vector quantization method.

7. The computer-implemented method of claim 6, wherein the vector quantization method is associated with at least one of binarization, scalar quantization, product quantization, or residual quantization.

8. The computer-implemented method of claim 1, wherein the information about the media content item includes a score indicating a level of confidence associated with recognizing, by the media processing technique, one or more objects of interest depicted in the media content item.

9. The computer-implemented method of claim 8, wherein determining whether to transmit at least the portion of the media content item to the one or more remote servers for the additional media processing further comprises determining whether the score at least meets a specified confidence threshold.

10. The computer-implemented method of claim 1, wherein the information about the media content item is produced in real-time based on utilizing the compressed CNN to apply the media processing technique to the media content item.

11. A system comprising:
at least one processor; and
a memory storing instructions that, when executed by the at least one processor, cause the system to perform:
receiving a compressed convolutional neural network (CNN);
acquiring a media content item to be processed;
utilizing the compressed CNN to apply a media processing technique to the media content item to produce information about the media content item; and
determining, based on at least some of the information about the media content item, whether to transmit at least a portion of the media content item to one or more remote servers for additional media processing.

12. The system of claim 11, wherein the instructions cause the system to further perform:
transmitting at least the portion of the media content item to the one or more remote servers for the additional media processing;
enabling one or more objects depicted in at least the portion of the media content item to be recognized based on the additional media processing; and
receiving information associated with the one or more objects recognized based on the additional media processing.

13. The system of claim 11, wherein the compressed CNN is generated based on a compression process performed remotely from the system.

14. The system of claim 13, wherein the compression process utilizes a matrix factorization method.

15. The system of claim 13, wherein the compression process utilizes a vector quantization method.

16. A non-transitory computer-readable storage medium including instructions that, when executed by at least one processor of a computing system, cause the computing system to perform a method comprising:
receiving a compressed convolutional neural network (CNN);
acquiring a media content item to be processed;
utilizing the compressed CNN to apply a media processing technique to the media content item to produce information about the media content item; and
determining, based on at least some of the information about the media content item, whether to transmit at least a portion of the media content item to one or more remote servers for additional media processing.

17. The non-transitory computer-readable storage medium of claim 16, wherein the instructions cause the computing system to further perform:
transmitting at least the portion of the media content item to the one or more remote servers for the additional media processing;
enabling one or more objects depicted in at least the portion of the media content item to be recognized based on the additional media processing; and
receiving information associated with the one or more objects recognized based on the additional media processing.

18. The non-transitory computer-readable storage medium of claim 16, wherein the compressed CNN is generated based on a compression process performed remotely from the computing system.

19. The non-transitory computer-readable storage medium of claim 18, wherein the compression process utilizes a matrix factorization method.

20. The non-transitory computer-readable storage medium of claim 18, wherein the compression process utilizes a vector quantization method.
